(19) United States
(12) Patent Application Publication
(10) Pub. No.: US 2026/0042707 A1
(43) Pub. Date: Feb. 12, 2026

(54) Alkali-Activated Material

(71) Applicant: Liverpool John Moores University, Liverpool (GB)

(72) Inventors: Monower SADIQUE, Liverpool (GB); Abdullah KADHIM, Liverpool (GB)

(21) Appl. No.: 19/123,534

(22) PCT Filed: Oct. 23, 2023
(86) PCT No.: PCT/GB2023/052769

§ 371 Date: Apr. 23, 2025

(30) Foreign Application Priority Data
Oct. 24, 2022 (GB) 2215742.4

(51) Int. Cl. C04B 28/00; C04B 7/02; C04B 12/00; C04B 12/04; C04B 14/06; C04B 28/04; C04B 40/02

(52) U.S. Cl. CPC C04B 28/006; C04B 7/02; C04B 12/005; C04B 12/04; C04B 14/06; C04B 28/04; C04B 40/0263; C04B 40/0277; C04B 2201/50

(57) ABSTRACT

A geopolymeric composition for forming an alkali-activated concrete material, the geopolymeric composition comprising metakaolin (MK), a source of calcium oxide and a source of aluminosilicate other than metakaolin (MK). A method for forming an alkali-activated concrete material and the use of such an alkali-activated concrete material are also described.

### FIELD

The present invention relates to compositions for forming an alkali-activated concrete material and to a method of forming an alkali-activated concrete material. In particular, the present invention relates to compositions and methods that make use of a geopolymeric composition comprising metakaolin (MK), a source of calcium oxide and a source of aluminosilicate other than metakaolin (MK). The present invention also relates to the use of the alkali-activated concrete material in construction.

### BACKGROUND

The use of concrete in construction is ubiquitous due to its versatility, high compressive strength and durability. However, there are many issues associated with the production of concrete, including for example the destruction of natural resources, the high amount of energy needed in processing and the production of greenhouse gases.

Concrete traditionally comprises a mixture of aggregates and paste. The paste coats the surface of the aggregates and binds them together into a solid mass, i.e., concrete. The paste typically comprises cement and water, which react via a chemical reaction known as hydration. This chemical reaction causes the paste to harden and gain strength.

The manufacturing of cement is believed to account for approximately 7% of CO₂ emissions worldwide, as the production of one tonne of cement results in approximately one tonne of CO₂. There is an increasing drive to reduce CO₂ emissions globally and thus in order to achieve this there is a need to provide viable alternatives to cement.

Geopolymeric compositions have been proposed as alternatives to cement. Geopolymers are formed by mixing an aluminosilicate precursor with an alkaline solution and may be considered as alkali-activated materials. Geopolymeric compositions typically provide adequate strength in a very short curing time, whilst maintaining mechanical properties such as durability in the final concrete product. However, in conventional two-part alkali activation, a solid raw material is activated with an alkaline chemical solution. These solutions are categorised as extremely corrosive materials and, from an operational viewpoint, they are difficult and expensive to handle, with significant occupational health and safety concerns.

It is also desirable to make use of construction and demolition wastes, such as brick, ceramic tiles and concrete, when forming alternative concrete and cement products. This potentially reduces the disposal requirements of such waste materials, for example transportation and disposal at landfill sites.

Commonly used waste materials include ground granulated blast furnace slag (GGBFS) and fly ash (PFA). GGBFS is a by-product waste material produced from iron manufacture while PFA is a waste material derived from coal combustion power plants. However, there is a high risk related to the production and availability of these materials. The production of PFA and GGBFS is expected to decrease significantly in the next 10 years due to new regulations regarding greenhouse gas emissions.

Therefore, there is a need to develop alternative geopolymeric compositions and sustainable activation methods.

It is an object of aspects of the present invention to provide an alternative to traditional cement and concrete products, for example by providing a geopolymeric composition and a composition for forming an alkali-activated concrete material, which addresses at least one disadvantage of the prior art, whether identified here or elsewhere, or to provide an alternative to existing alkali-activated concrete materials and methods of preparing them. For example, it may be an aim of the present invention to provide an alkali-activated concrete material comprising waste materials whilst maintaining acceptable properties for use in construction.

### SUMMARY OF THE INVENTION

According to aspects of the present invention, there are provided compositions (including a geopolymeric composition) for forming an alkali-activated concrete material, a method of forming an alkali-activated concrete material, an alkali-activated concrete material and structures prepared from the alkali-activated concrete material as set forth in the appended claims. Other features of the invention will be apparent from the dependent claims, and from the description which follows.

According to a first aspect of the present invention, there is provided a geopolymeric composition for forming an alkali-activated concrete material, the geopolymeric composition comprising metakaolin (MK), a source of calcium oxide and a source of aluminosilicate other than metakaolin (MK).

According to a second aspect of the present invention, there is provided a composition for forming an alkali-activated concrete material, the composition comprising a geopolymeric composition, water and an aggregate, wherein the geopolymeric composition comprises metakaolin (MK), a source of calcium oxide and a source of aluminosilicate other than metakaolin (MK).

According to a third aspect of the present invention, there is provided a method of forming an alkali-activated concrete material, the method comprising:
(1) mixing a geopolymeric composition, water and an aggregate to obtain a concrete mix; and
(2) curing the concrete mix obtained in step (1);
wherein the geopolymeric composition comprises metakaolin (MK), a source of calcium oxide and a source of aluminosilicate other than metakaolin (MK).

According to a fourth aspect of the present invention, there is provided a hybrid binder composition comprising a geopolymeric composition according to the first aspect of the invention and cement, preferably Ordinary Portland Cement (OPC).

According to a fifth aspect of the present invention, there is provided an alkali-activated concrete material obtained or obtainable by the method of the third aspect of the invention.

According to a sixth aspect of the present invention, there is provided an alkali-activated concrete material derived from a geopolymeric composition, water and an aggregate, wherein the geopolymeric composition comprises metakaolin (MK), a source of calcium oxide and a source of aluminosilicate other than metakaolin (MK); wherein the alkali-activated concrete material has a compressive strength of at least 10 MPa as measured by compression testing.

According to a seventh aspect of the present invention, there is provided a concrete structure formed from an alkali-activated concrete material according to the fifth or sixth aspect of the invention.

According to an eighth aspect of the present invention, there is provided a use of an alkali-activated concrete material according to the fifth or sixth aspect of the invention in construction.

According to a ninth aspect of the present invention, there is provided a use of a concrete structure according to the seventh aspect of the invention in construction.

The compositions and methods of the present invention provide an alternative to traditional cement and concrete products, such as fired bricks, and may result in reduced CO₂ emissions, as well as making use of waste products. The alkali-activated concrete material formed by the compositions and methods of the present invention further maintains acceptable mechanical properties, such as high compressive strength, desirable flexural strength, low chloride ion penetrability and/or low water absorption. The geopolymeric composition of the first aspect of the present invention may be suitable for use to form an alkali-activated material without the need for commercial chemical activators. The geopolymeric composition may also be completely free of GGBFS and/or fly ash.

### DETAILED DESCRIPTION OF THE INVENTION

Unless otherwise stated, the following terms used in the specification and claims have the meanings set out below.

The first aspect of the present invention relates to a geopolymeric composition for forming an alkali-activated concrete material.

The second aspect of the present invention relates to a composition for forming an alkali-activated concrete material. The composition of the second aspect may alternatively be referred to as a mortar or mortar composition.

By the term “geopolymeric composition” we mean a composition that acts as a paste to bind aggregate together into a solid mass, i.e., concrete (which concrete may be formed into a structure such as a brick). The geopolymeric composition is suitable for forming an alkali-activated concrete material. As will be known by the skilled person, alkali-activation typically involves a chemical reaction between an aluminosilicate or aluminosilicate precursor and an alkaline activator to produce a paste (or geopolymeric composition) that is capable of setting and hardening within a reasonable curing time period for construction purposes. The geopolymeric composition described herein may alternatively be described as a binder. It may also additionally or alternatively be referred to as a cementitious material or cementitious composition.

The geopolymeric composition is suitably an alternative to cement, for example Ordinary Portland Cement (OPC).

The geopolymeric composition of the first and second aspects suitably acts as a one-part alkali-activated geopolymeric composition. This is in contrast to two-part alkali-activated geopolymeric compositions in which a reaction between concentrated aqueous solutions of alkali hydroxide, silicate, carbonate, or sulphate and solid aluminosilicate precursor occurs.

Suitably, in the geopolymeric composition of the present invention, alkali-activation occurs in the presence of water without the need for additional alkali activator solutions. Thus, the geopolymeric composition of the first and second aspects may be referred to as a one-part alkali-activated geopolymeric composition.

Thus, by the term “alkali-activated concrete material” we mean a concrete material comprising aggregate and a paste (or geopolymeric composition) that has been formed by means of alkali-activation.

The compositions of the first and second aspects of the present invention comprise a geopolymeric composition comprising metakaolin (MK), a source of calcium oxide and a source of aluminosilicate other than metakaolin (MK).

Suitably, the compositions of the first and second aspects of the present invention comprise a geopolymeric composition comprising a first component which is metakaolin (MK), a second component which is a source of calcium oxide and a third component which is a source of aluminosilicate, wherein the first, second and third components are different to one another.

Suitably, the compositions of the first and second aspects of the present invention comprise a geopolymeric composition comprising a first component which is metakaolin (MK), a second component which is a source of calcium oxide and a third component which is a source of aluminosilicate other than metakaolin (MK), wherein the first, second and third components are different to one another.

As known in the art, metakaolin (MK) is the anhydrous calcined form of the clay mineral kaolinite (which is sometimes referred to as China clay) and is produced by controlled thermal treatment of kaolin.

MK suitably comprises oxide compounds. Suitably the MK comprises one or more oxide compounds selected from silicon dioxide (SiO₂), aluminium oxide (Al₂O₃), iron oxide (Fe₂O₃), calcium oxide (CaO), magnesium oxide (MgO), sodium oxide (Na₂O), potassium oxide (K₂O) and titanium dioxide (TiO₂).

The MK may be considered as a first source of aluminosilicate.

Suitably, the MK may have a silicon dioxide content of up to 50 wt %, suitably up to 60 wt % or 70 wt %, for example up to 80 wt %. Suitably, the MK may have a silicon dioxide content of at least 10 wt %, suitably at least 15 wt % or 20 wt %, for example at least 30 wt % or at least 40 wt %. Suitably, the MK may have a silicon dioxide content of from 10 to 80 wt %, for example from 15 wt % to 70 wt % or from 20 wt % to 60 wt %, such as from 45 wt % to 60 wt %.

Suitably, the MK may have an aluminium oxide content of up to 80 wt %, suitably up to 70 wt % or 60 wt %, for example up to 50 wt %. Suitably, the MK may have an aluminium oxide content of at least 10 wt %, suitably at least 15 wt % or 20 wt %, for example at least 30 wt % or at least 40 wt %. Suitably, the MK may have an aluminium oxide content of from 10 to 80 wt %, for example from 10 wt % to 70 wt %, or from 20 wt % to 70 wt %, such as from 30 wt % to 60 wt %, for example from 30 wt % to 50 wt %.

Suitably, the MK may have an iron oxide content of up to 3 wt %, suitably up to 5 wt %. Suitably, the MK may have an iron oxide content of at least 0.1 wt %, for example at least 0.5 wt % or at least 1 wt %. Suitably, the MK may have an iron oxide content of from 0.1 to 5 wt %, for example from 1 wt % to 3 wt %.

Suitably, the MK comprises a majority of silicon dioxide and aluminium oxide. For example, the MK may comprise more than 50 wt % silicon dioxide and aluminium oxide (i.e., more than 50 wt % of the MK is comprised of silicon dioxide and aluminium oxide), such as over 60 wt % or over 70 wt % silicon dioxide and aluminium oxide. Suitably, the MK may comprise over 80 wt % silicon dioxide and aluminium oxide, for example over 90 wt % silicon dioxide and aluminium oxide.

As will be appreciated by a person skilled in the art, the composition of MK may be analysed by powder X-ray diffraction (PXRD) using techniques known in the art. The PXRD pattern of MK suitably comprises peaks representative of quartz. The PXRD pattern of MK suitably comprises peaks representative of mullite. The PXRD pattern of MK suitably comprises peaks representative of anatas. The PXRD pattern of MK suitably comprises peaks representative of illite.

The geopolymeric composition of the first and second aspect comprises a source of calcium oxide. Any suitable source of calcium oxide may be used. For example, calcium oxide, which is also known as quicklime, may be used. Suitably, the source of calcium oxide is a by-product material.

By “a source of calcium oxide” we mean to refer to sources of calcium oxide having a calcium oxide content of at least 10 wt %. Suitably, the source of calcium oxide has a calcium oxide content of at least 15 wt %, for example at least 20 wt % or at least 25 wt %.

Suitably, the source of calcium oxide may have a calcium oxide content of up to 45 wt %, suitably up to 50 wt % or 60 wt %, for example up to 65 wt % or up to 70 wt %. Suitably, the source of calcium oxide may have a calcium oxide content of at least 30 wt %, for example at least 35 wt % or at least 40 wt %. Suitably, the source of calcium oxide may have a calcium oxide content of from 30 to 70 wt %, for example from 35 wt % to 65 wt % or from 40 wt % to 65 wt %, such as from 45 wt % to 55 wt %.

The source of calcium oxide may also comprise one or more oxide compounds selected from silicon dioxide (SiO₂), aluminium oxide (Al₂O₃), iron oxide (Fe₂O₃), magnesium oxide (MgO), sodium oxide (Na₂O), potassium oxide (K₂O) and titanium dioxide (TiO₂).

Suitably, the source of calcium oxide may have a silicon dioxide content of up to 30 wt %, suitably up to 35 wt % or 40 wt %, for example up to 45 wt %. Suitably, the source of calcium oxide may have a silicon dioxide content of at least 5 wt %, suitably at least 10 wt % or 15 wt %. Suitably, the source of calcium oxide may have a silicon dioxide content of from 5 to 45 wt %, for example from 10 to 40 wt % or from 15 to 35 wt % or from 15 to 30 wt %.

Suitably, the source of calcium oxide comprises a majority of calcium oxide and silicon dioxide, for example the source of calcium oxide may comprise more than 50 wt % calcium oxide and silicon dioxide (i.e., more than 50 wt % of the source of calcium oxide is comprised of calcium oxide and silicon dioxide), for example more than 55 wt % calcium oxide and silicon dioxide, such as more than 60 wt % calcium oxide and silicon dioxide.

Suitably, the source of calcium oxide may have a potassium oxide content of up to 4 wt %, such as up to 5 wt %, suitably up to 7 wt %. Suitably, the source of calcium oxide may have a potassium oxide content of at least 1 wt %, suitably at least 3 wt %. Suitably, the source of calcium oxide may have a potassium oxide content of from 1 to 7 wt %, for example from 3 to 7 wt %.

Suitably, the source of calcium oxide may have an aluminium oxide content of up to 2 wt %, such as up to 3 wt %. Suitably, the source of calcium oxide may have an aluminium oxide content of at least 0.5 wt %, suitably at least 1 wt %. Suitably, the source of calcium oxide may have an aluminium oxide content of from 0.5 to 3 wt %, for example from 1 to 2 wt %.

Suitably, the source of calcium oxide may have an iron oxide content of up to 3 wt %, such as up to 5 wt %. Suitably, the source of calcium oxide may have an iron oxide content of at least 0.5 wt %, suitably at least 1 wt %. Suitably, the source of calcium oxide may have an iron oxide content of from 0.5 to 5 wt %, for example from 1 to 5 wt %.

Suitably, the source of calcium oxide may have a sodium oxide content of up to 2.5 wt %, such as up to 3.5 wt %. Suitably, the source of calcium oxide may have a sodium oxide content of at least 0.5 wt %, suitably at least 1 wt %. Suitably, the source of calcium oxide may have a sodium oxide content of from 0.5 to 3.5 wt %, for example from 1 to 2.5 wt %.

Suitably, the source of calcium oxide may have a magnesium oxide content of up to 2 wt %, such as up to 3 wt %. Suitably, the source of calcium oxide may have a magnesium oxide content of at least 0.5 wt %, suitably at least 1 wt %. Suitably, the source of calcium oxide may have a magnesium oxide content of from 0.5 to 3 wt %, for example from 1 to 2 wt %.

Suitably, the source of calcium oxide may have a calcium oxide content of from 30 to 70 wt %, a silicon dioxide content of from 15 to 35 wt % and a potassium oxide content of from 1 to 7 wt %.

Suitably, the source of calcium oxide may have a calcium oxide content of from 30 to 70 wt %, a silicon dioxide content of from 15 to 30 wt % and a potassium oxide content of from 3 to 7 wt %.

Suitably, the source of calcium oxide may have a calcium oxide content of from 30 to 70 wt %, a silicon dioxide content of from 15 to 35 wt %, a potassium oxide content of from 1 to 7 wt %, an aluminium oxide content of from 0.5 to 3 wt %, an iron oxide content of from 0.5 to 5 wt %, a sodium oxide content of from 0.5 to 3.5 wt % and a magnesium oxide content of from 0.5 to 3 wt %.

Suitably, the source of calcium oxide may have a calcium oxide content of from 30 to 70 wt %, a silicon dioxide content of from 15 to 30 wt %, a potassium oxide content of from 3 to 7 wt %, an aluminium oxide content of from 1 to 2 wt %, an iron oxide content of from 1 to 5 wt %, a sodium oxide content of from 1 to 2.5 wt % and a magnesium oxide content of from 1 to 2 wt %.

Suitably, the source of calcium oxide may have calcium oxide content of from 40 wt % to 65 wt %, a silicon dioxide content of from 15 to 35 wt % and a potassium oxide content of from 1 to 7 wt %.

Suitably, the source of calcium oxide may have calcium oxide content of from 40 wt % to 65 wt %, a silicon dioxide content of from 15 to 30 wt % and a potassium oxide content of from 3 to 7 wt %.

Suitably, the source of calcium oxide may have calcium oxide content of from 40 wt % to 65 wt %, a silicon dioxide content of from 15 to 35 wt %, a potassium oxide content of from 1 to 7 wt %, an aluminium oxide content of from 0.5 to 3 wt %, an iron oxide content of from 0.5 to 5 wt %, a sodium oxide content of from 0.5 to 3.5 wt % and a magnesium oxide content of from 0.5 to 3 wt %.

Suitably, the source of calcium oxide may have calcium oxide content of from 40 wt % to 65 wt %, a silicon dioxide content of from 15 to 30 wt %, a potassium oxide content of from 3 to 7 wt %, an aluminium oxide content of from 1 to 2 wt %, an iron oxide content of from 1 to 5 wt %, a sodium oxide content of from 1 to 2.5 wt % and a magnesium oxide content of from 1 to 2 wt %.

Suitably, the source of calcium oxide is not lime kiln dust (LKD).

The source of calcium oxide is suitably bypass dust (BPD). BPD is dust that is discarded from a bypass system dedusting unit, which may be found in suspension preheater, pre-calciner and grate preheater kilns, for example in the cement production industry. BPD comprises fully calcined kiln feed material. BPD extracted from a kiln system suitably comprises calcium oxide (CaO). No thermal activation or treatment of the BPD is needed prior to use in the geopolymeric compositions of the invention.

Suitably, the BPD may have a calcium oxide content of up to 45 wt %, suitably up to 50 wt % or 60 wt %, for example up to 65 wt % or up to 70 wt %. Suitably, the BPD may have a calcium oxide content of at least 30 wt %, for example at least 35 wt % or at least 40 wt %. Suitably, the BPD may have a calcium oxide content of from 30 to 70 wt %, for example from 35 wt % to 65 wt % or from 40 wt % to 65 wt %.

The BPD may also comprise one (i.e. in addition to calcium oxide) or more oxide compounds selected from silicon dioxide (SiO₂), aluminium oxide (Al₂O₃), iron oxide (Fe₂O₃), magnesium oxide (MgO), sodium oxide (Na₂O), potassium oxide (K₂O) and titanium dioxide (TiO₂).

Suitably, the BPD may have a silicon dioxide content of up to 30 wt %, suitably up to 35 wt % or 40 wt %, for example up to 45 wt %. Suitably, the BPD may have a silicon dioxide content of at least 5 wt %, suitably at least 10 wt % or 15 wt %. Suitably, the BPD may have a silicon dioxide content of from 5 to 45 wt %, for example from 10 to 40 wt % or from 15 to 35 wt % or from 15 to 30 wt %.

Suitably, the BPD content comprises a majority of calcium oxide and silicon dioxide, for example the BPD content may comprise more than 50 wt % calcium oxide and silicon dioxide (i.e., more than 50 wt % of the BPD is comprised of calcium oxide and silicon dioxide), for example more than 55 wt % calcium oxide and silicon dioxide, such as more than 60 wt % calcium oxide and silicon dioxide.

Suitably, the BPD may have a potassium oxide content of up to 4 wt %, such as up to 5 wt %, suitably up to 7 wt %. Suitably, the BPD may have a potassium oxide content of at least 1 wt %, suitably at least 3 wt %. Suitably, the BPD may have a potassium oxide content of from 1 to 7 wt %, for example from 3 to 7 wt %.

Suitably, the BPD may have an aluminium oxide content of up to 2 wt %, such as up to 3 wt %. Suitably, the BPD may have an aluminium oxide content of at least 0.5 wt %, suitably at least 1 wt %. Suitably, the BPD may have an aluminium oxide content of from 0.5 to 3 wt %, for example from 1 to 2 wt %.

Suitably, the BPD may have an iron oxide content of up to 3 wt %, such as up to 5 wt %. Suitably, the BPD may have an iron oxide content of at least 0.5 wt %, suitably at least 1 wt %. Suitably, the BPD may have an iron oxide content of from 0.5 to 5 wt %, for example from 1 to 5 wt %.

Suitably, the BPD may have a sodium oxide content of up to 2.5 wt %, such as up to 3.5 wt %. Suitably, the BPD may have a sodium oxide content of at least 0.5 wt %, suitably at least 1 wt %. Suitably, the BPD may have a sodium oxide content of from 0.5 to 3.5 wt %, for example from 1 to 2.5 wt %.

Suitably, the BPD may have a magnesium oxide content of up to 2 wt %, such as up to 3 wt %. Suitably, the BPD may have a magnesium oxide content of at least 0.5 wt %, suitably at least 1 wt %. Suitably, the BPD may have a magnesium oxide content of from 0.5 to 3 wt %, for example from 1 to 2 wt %.

Suitably, the BPD may have a calcium oxide content of from 30 to 70 wt %, a silicon dioxide content of from 15 to 35 wt % and a potassium oxide content of from 1 to 7 wt %.

Suitably, the BPD may have a calcium oxide content of from 30 to 70 wt %, a silicon dioxide content of from 15 to 30 wt % and a potassium oxide content of from 3 to 7 wt %.

Suitably, the BPD may have a calcium oxide content of from 30 to 70 wt %, a silicon dioxide content of from 15 to 35 wt %, a potassium oxide content of from 1 to 7 wt %, an aluminium oxide content of from 0.5 to 3 wt %, an iron oxide content of from 0.5 to 5 wt %, a sodium oxide content of from 0.5 to 3.5 wt % and a magnesium oxide content of from 0.5 to 3 wt %.

Suitably, the BPD may have a calcium oxide content of from 30 to 70 wt %, a silicon dioxide content of from 15 to 30 wt %, a potassium oxide content of from 3 to 7 wt %, an aluminium oxide content of from 1 to 2 wt %, an iron oxide content of from 1 to 5 wt %, a sodium oxide content of from 1 to 2.5 wt % and a magnesium oxide content of from 1 to 2 wt %.

Suitably, the BPD may have calcium oxide content of from 40 wt % to 65 wt %, a silicon dioxide content of from 15 to 35 wt % and a potassium oxide content of from 1 to 7 wt %.

Suitably, the BPD may have calcium oxide content of from 40 wt % to 65 wt %, a silicon dioxide content of from 15 to 30 wt % and a potassium oxide content of from 3 to 7 wt %.

Suitably, the BPD may have calcium oxide content of from 40 wt % to 65 wt %, a silicon dioxide content of from 15 to 35 wt %, a potassium oxide content of from 1 to 7 wt %, an aluminium oxide content of from 0.5 to 3 wt %, an iron oxide content of from 0.5 to 5 wt %, a sodium oxide content of from 0.5 to 3.5 wt % and a magnesium oxide content of from 0.5 to 3 wt %.

Suitably, the BPD may have calcium oxide content of from 40 wt % to 65 wt %, a silicon dioxide content of from 15 to 30 wt %, a potassium oxide content of from 3 to 7 wt %, an aluminium oxide content of from 1 to 2 wt %, an iron oxide content of from 1 to 5 wt %, a sodium oxide content of from 1 to 2.5 wt % and a magnesium oxide content of from 1 to 2 wt %.

The amounts of the oxide compounds in the source of calcium oxide and BPD as discussed herein provide advantages in use. For example, the quantities of potassium oxide and sodium oxide provide increased reactivity to the geopolymeric composition, which is believed to be due to the resulting (high) pH of the source of calcium oxide or BP, which increases the dissolution rate and provides advantageous strength and mechanical properties.

Suitably, when dissolved in water, the BPD has a pH of greater than 8, such as greater than 9. The BPD is suitably alkaline in aqueous solution.

As will be appreciated by a person skilled in the art, the composition of BPD may be analysed by powder X-ray diffraction (PXRD) using techniques known in the art. The PXRD pattern of BPD suitably comprises peaks representative of calcite (CC). The PXRD pattern of BPD suitably comprises peaks representative of lime (Ca).

The geopolymeric composition of the first and second aspect comprises a source of aluminosilicate other than metakaolin (MK). Any suitable source of aluminosilicate may be used. As known in the art, an aluminosilicate is a silicate in which aluminium replaces some of the silicon, especially a rock-forming mineral such as a feldspar or a clay mineral. The source of aluminosilicate may alternatively be referred to herein as an aluminosilicate or aluminosilicate precursor.

The source of aluminosilicate is suitably an additional source of aluminosilicate to MK, i.e., a further or second source of aluminosilicate.

By “a source of aluminosilicate” we mean to refer to sources of aluminosilicate having a silicon dioxide content of at least 10 wt % and an aluminium oxide content of at least 10 wt %.

Suitably, the source of aluminosilicate other than metakaolin (MK) may have a silicon dioxide content of up to 35 wt %, suitably up to 40 wt % or 50 wt %, for example up to 55 wt % or up to 60 wt %, such as up to 70 wt %. Suitably, the source of aluminosilicate other than metakaolin (MK) may have a silicon dioxide content of at least 20 wt %, for example at least 25 wt % or at least 30 wt %, such as at least 35 wt %. Suitably, the source of aluminosilicate other than metakaolin (MK) may have a silicon dioxide content of from 20 to 70 wt %, for example from 25 wt % to 65 wt % or from 35 wt % to 55 wt %.

Suitably, the source of aluminosilicate other than metakaolin (MK) may have an aluminium oxide content of up to 20 wt % or 25 wt %, for example up to 30 wt % or up to 40 wt %, such as up to 45 wt % or 50 wt %. Suitably, the source of aluminosilicate other than metakaolin (MK) may have an aluminium oxide content of at least 10 wt %, such as for example 15 wt % or for example at least 20 wt %. Suitably, the source of aluminosilicate other than metakaolin (MK) may have an aluminium oxide content of from 10 to 50 wt %, for example from 15 wt % to 45 wt % or from 20 wt % to 40 wt %.

Suitably, the source of aluminosilicate other than metakaolin (MK) comprises a majority of aluminium oxide and silicon dioxide, for example the source of aluminosilicate other than metakaolin (MK) may comprise more than 50 wt % aluminium oxide and silicon dioxide (i.e., more than 50 wt % of the source of aluminosilicate other than metakaolin (MK) is comprised of aluminium oxide and silicon dioxide), for example more than 55 wt % aluminium oxide and silicon dioxide, such as more than 60 wt % aluminium oxide and silicon dioxide.

The source of aluminosilicate other than metakaolin (MK) may also comprise one or more oxide compounds selected from calcium oxide (CaO), iron oxide (Fe₂O₃), magnesium oxide (MgO), sodium oxide (Na₂O), potassium oxide (K₂O), titanium dioxide (TiO₂).

Suitably, the source of aluminosilicate other than metakaolin (MK) may have a potassium oxide content of up to 4 wt %, such as up to 5 wt % or up to 8 wt %, suitably up to 10 wt %. Suitably, the source of aluminosilicate other than metakaolin (MK) may have a potassium oxide content of at least 1 wt %, suitably at least 4 wt %. Suitably, the source of aluminosilicate other than metakaolin (MK) may have a potassium oxide content of from 1 to 10 wt %, for example from 4 to 8 wt %.

The source of aluminosilicate other than metakaolin (MK) is suitably natural pozzolan (NP). Natural pozzolan is otherwise known as volcanic tuff. Natural pozzolan is formed by the quenching of molten magma when it is projected to the atmosphere upon explosive volcanic eruptions. NP suitably comprises aluminium oxide and silicon dioxide.

Suitably, the NP may have a silicon dioxide content of up to 35 wt %, suitably up to 40 wt % or 50 wt %, for example up to 55 wt % or up to 60 wt %, such as up to 70 wt %. Suitably, the NP may have a silicon dioxide content of at least 20 wt %, for example at least 25 wt % or at least 30 wt %, such as at least 35 wt %. Suitably, the NP may have a silicon dioxide content of from 20 to 70 wt %, for example from 25 wt % to 65 wt % or from 35 wt % to 55 wt %.

Suitably, the NP may have an aluminium oxide content of up to 20 wt % or 25 wt %, for example up to 30 wt % or up to 40 wt %, such as up to 45 wt % or 50 wt %. Suitably, the NP may have an aluminium oxide content of at least 10 wt %, such as for example 15 wt % or for example at least 20 wt %. Suitably, the NP may have an aluminium oxide content of from 10 to 50 wt %, for example from 15 wt % to 45 wt % or from 20 wt % to 40 wt %.

Suitably, the NP content comprises a majority of aluminium oxide and silicon dioxide, for example the NP content may comprise more than 50 wt % aluminium oxide and silicon dioxide (i.e., more than 50 wt % of the NP is comprised of calcium oxide and silicon dioxide), for example more than 55 wt % aluminium oxide and silicon dioxide, such as more than 60 wt % aluminium oxide and silicon dioxide.

The NP may also comprise one or more oxide compounds selected from calcium oxide (CaO), iron oxide (Fe₂O₃), magnesium oxide (MgO), sodium oxide (Na₂O), potassium oxide (K₂O) and titanium dioxide (TiO₂).

Suitably, the NP may have a potassium oxide content of up to 4 wt %, such as up to 5 wt % or up to 8 wt %, suitably up to 10 wt %. Suitably, the NP may have a potassium oxide content of at least 1 wt %, suitably at least 4 wt %. Suitably, the NP may have a potassium oxide content of from 1 to 10 wt %, for example from 4 to 8 wt %.

As will be appreciated by a person skilled in the art, the composition of NP may be analysed by powder X-ray diffraction (PXRD) using techniques known in the art. The PXRD pattern of NP suitably comprises peaks representative of clinoptilolite. The PXRD pattern of NP suitably comprises peaks representative of edenite. The PXRD pattern of NP suitably comprises peaks representative of quartz. The PXRD pattern of NP suitably comprises peaks representative of anatas.

The metakaolin (MK), source of calcium oxide, source of aluminosilicate other than metakaolin, BPD and NP disclosed herein may comprise the oxide compounds disclosed herein in any combination, including any combination of the amounts of each oxide compound thereof, as disclosed herein.

The geopolymeric composition of the first and second aspect comprises metakaolin (MK), a source of calcium oxide and a source of aluminosilicate other than metakaolin (MK).

Suitably, the geopolymeric composition comprises at least 10 wt %, for example at least 20 wt % or 30 wt % MK. Suitably, the geopolymeric composition comprises up to 70 wt %, for example up to 60 wt % or 50 wt % MK. Suitably, the geopolymeric composition comprises from 10 wt % to 70 wt %, for example from 30 wt % to 60 wt %, MK. For example, the geopolymeric composition may comprise from 20 to 40 wt % MK, for example 25 to 35 wt %, such as about 33 wt % MK.

Suitably, the geopolymeric composition comprises at least 10 wt %, for example at least 20 wt % or 30 wt % of the source of calcium oxide. Suitably, the geopolymeric composition comprises up to 70 wt %, for example up to 60 wt % or 50 wt % of the source of calcium oxide. Suitably, the geopolymeric composition comprises from 10 wt % to 70 wt %, for example from 30 wt % to 60 wt %, of the source of calcium oxide. For example, the geopolymeric composition may comprise from 20 to 40 wt % of the source of calcium oxide, for example 25 to 35 wt %, such as about 33 wt % of the source of calcium oxide.

The source of calcium oxide is suitably BPD.

In such embodiments, the geopolymeric composition comprises at least 10 wt %, for example at least 20 wt % or 30 wt % BPD. Suitably, the geopolymeric composition comprises up to 70 wt %, for example up to 60 wt % or 50 wt % BPD. Suitably, the geopolymeric composition comprises from 10 wt % to 70 wt %, for example from 30 wt % to 60 wt %, BPD. For example, the geopolymeric composition may comprise from 20 to 40 wt % BPD, for example 25 to 35 wt %, such as about 33 wt % BPD.

Suitably, the geopolymeric composition comprises at least 10 wt %, for example at least 20 wt % or 30 wt % of the source of aluminosilicate other than metakaolin (MK). Suitably, the geopolymeric composition comprises up to 70 wt %, for example up to 60 wt % or 50 wt % of the source of aluminosilicate other than metakaolin (MK). Suitably, the geopolymeric composition comprises from 10 wt % to 70 wt %, for example from 30 wt % to 60 wt %, of the source of aluminosilicate other than metakaolin (MK). For example, the geopolymeric composition may comprise from 20 to 40 wt % of the source of aluminosilicate other than metakaolin (MK), for example 25 to 35 wt %, such as about 33 wt % of the source of aluminosilicate other than metakaolin (MK).

The source of aluminosilicate other than metakaolin (MK) is suitably NP.

Suitably, the geopolymeric composition comprises at least 10 wt %, for example at least 20 wt % or 30 wt % NP. Suitably, the geopolymeric composition comprises up to 70 wt %, for example up to 60 wt % or 50 wt % NP. Suitably, the geopolymeric composition comprises from 10 wt % to 70 wt %, for example from 30 wt % to 60 wt %, NP or from 30 to 50 wt %. For example, the geopolymeric composition may comprise from 20 to 40 wt % NP, such as about 33 wt % NP.

The geopolymeric composition suitably comprises from 20 to 40 wt %, for example 25 to 35 wt %, of MK; from 20 to 40 wt %, for example 25 to 35 wt %, of the source of calcium oxide; and from 20 to 40 wt %, for example 25 to 35 wt %, of the source of aluminosilicate other than metakaolin (MK).

Suitably the geopolymeric composition comprises from 20 to 40 wt %, for example 25 to 35 wt %, of MK; from 20 to 40 wt %, for example 25 to 35 wt %, of BPD; and from 20 to 40 wt %, for example 25 to 35 wt %, of the source of aluminosilicate other than metakaolin (MK).

Suitably the geopolymeric composition comprises from 20 to 40 wt %, for example 25 to 35 wt %, of MK; from 20 to 40 wt %, for example 25 to 35 wt %, of the source of calcium oxide; and from 20 to 40 wt %, for example 25 to 35 wt %, of NP.

Suitably the geopolymeric composition comprises from 20 to 40 wt %, for example 25 to 35 wt %, of MK; from 20 to 40 wt %, for example 25 to 35 wt %, of BPD; and from 20 to 40 wt %, for example 25 to 35 wt %, of NP.

Preferably the geopolymeric composition comprises MK, a source of calcium oxide and a source of aluminosilicate other than metakaolin (MK) in a 1:1:1 weight ratio.

Preferably the geopolymeric composition comprises MK, BPD and NP in a 1:1:1 weight ratio. Suitably the geopolymeric composition consists essentially of metakaolin (MK), a source of calcium oxide and a source of aluminosilicate other than metakaolin (MK).

Suitably the geopolymeric composition consists of metakaolin (MK), a source of calcium oxide and a source of aluminosilicate other than metakaolin (MK).

Suitably the geopolymeric composition consists essentially of metakaolin (MK), bypass dust (BPD) and natural pozzolan (NP).

Suitably the geopolymeric composition consists of metakaolin (MK), bypass dust (BPD) and natural pozzolan (NP).

The compositions of the first and second aspects of the present invention suitably do not comprise an additional alkaline activator. By the term “additional alkaline activator” we mean an additional alkaline compound that can react with an aluminosilicate or aluminosilicate precursor to produce a paste that is capable of setting and hardening within a reasonable curing time period for construction purposes.

Suitably the compositions of the first and second aspects of the present invention do not comprise an alkaline activator comprising sodium silicate (Na₂SiO₃), sodium hydroxide (NaOH) or combinations thereof.

The geopolymeric composition of the first and second aspects may be combined with cement to form a hybrid binder composition. The geopolymeric composition may be combined with Ordinary Portland Cement (OPC). For example, the hybrid binder composition may comprise from 10 to 90 wt % of the geopolymeric composition and from 90 to 10 wt % of cement, suitably OPC.

The composition of the second aspect of the invention comprises an aggregate. Any suitable aggregate may be used. Suitably, the aggregate comprises sand, gravel, limestone, sandstone, chalk, soil or combinations thereof.

Suitably, the aggregate is a fine aggregate. By the term “fine aggregate” we mean that the aggregate comprises particles with a diameter of less than 20 mm. The particle size may be determined using the Particle Size Distribution test according to BS EN 933-1:1997). For example, the aggregate may comprise particles with a diameter of less than 4 mm. Suitably, the aggregate may comprise particles with a diameter of less than 0.01 mm.

Suitably, the weight ratio of aggregate to geopolymeric composition in the composition of the second aspect may be from 1:2 to 4:1, for example from 1:1 to 3:1, such as about 2:1.

Suitably, the aggregate comprises sand. Suitably, the weight ratio of sand to geopolymeric composition in the composition of the second aspect may be from 1:2 to 4:1, for example from 1:1 to 3:1, such as about 2:1.

The first and second aspects of the present invention provide compositions that are useful for forming an alkali-activated concrete material. The alkali-activated concrete material may be made by any suitable method.

The present invention may provide an alkali-activated concrete material derived from a geopolymeric composition, water and an aggregate, wherein the geopolymeric composition comprises metakaolin (MK), a source of calcium oxide and a source of aluminosilicate other than metakaolin (MK). The alkali-activated concrete material, aggregate and geopolymeric composition are as described previously.

The alkali-activated concrete material derived from a geopolymeric composition may have a compressive strength of at least 10 MPa. In some embodiments the alkali-activated concrete material has a compressive strength of at least 20 MPa, suitably of at least 30 MPa. In some embodiments the alkali-activated concrete material has a compressive strength of at least 40 MPa, for example at least 50 MPa. Suitably, the alkali-activated concrete material has a compressive strength of up to 60 MPa, for example up to 70 MPa. Suitably, the alkali-activated concrete material has a compressive strength of from 10 MPa to 70 MPa. References to compressive strength are as measured by compression testing.

Suitable methods of determining the compressive strength will be known to those skilled in the art. For example, the compression strength may be determined by a method according to BS EN 196-1.

The third aspect of the invention provides a method of forming an alkali-activated concrete material, the method comprising:
(1) mixing a geopolymeric composition, water and an aggregate to obtain a concrete mix; and
(2) curing the concrete mix obtained in step (1);
wherein the geopolymeric composition comprises metakaolin (MK), a source of calcium oxide and a source of aluminosilicate other than metakaolin (MK).

References and preferences set out above in relation to the aggregate, geopolymeric composition, MK, a source of calcium oxide and a source of aluminosilicate other than metakaolin (MK) in relation to the first and second aspects of the invention apply equally to the third aspect of the invention.

Suitably, the steps of the method of the third aspect are carried out in the order of step (1) followed by step (2).

In step (1) the aggregate, geopolymeric composition and water are mixed to obtain a concrete mix. In step (1), water may be present by means of addition of water or an aqueous solution.

In some embodiments, in step (1), the aggregate and geopolymeric composition are first mixed together and water is then added to the resultant mixture. Alternatively, the geopolymeric composition, aggregate and water may all be mixed together in one step. The concrete mix may be in a flowable state following the mixing of the aforementioned components.

Suitably, the geopolymeric composition is prepared by mixing or blending the metakaolin (MK), a source of calcium oxide and a source of aluminosilicate other than metakaolin (MK). Suitably the geopolymeric composition is formed as a substantially dry geopolymeric composition.

By a “substantially dry geopolymeric composition” we mean that the water content of the geopolymeric composition is from 0 wt % to 3 wt %. Suitably, the substantially dry geopolymeric composition may be completely free of water.

Mixing may be accomplished by any suitable means. Suitably, once combined, the geopolymeric composition and aggregate are mixed using a mechanical mixer. Suitably the geopolymeric composition and aggregate may be mixed for up to 20 minutes, for example up to 15 minutes or up to 10 minutes. Suitably the geopolymeric composition and aggregate may be mixed for at least 30 seconds, suitably at least 1 minute. Suitably the geopolymeric composition and aggregate may be mixed for 2 to 5 minutes.

For example, the metakaolin (MK), a source of calcium oxide and a source of aluminosilicate other than metakaolin (MK) may be combined and mixed with sand and additional water.

The presence of water is believed to ensure the hydrolysis of any dissolved Al³⁺, Ca²⁺ and Si⁴⁺ ions and dissolve solid particles.

Suitably, the geopolymeric composition, aggregate, and water are combined and mixed in a mechanical mixer. Suitably the geopolymeric composition, aggregate and water are mixed for up to 20 minutes, for example up to 15 minutes or up to 10 minutes. Suitably the geopolymeric composition, aggregate and water are combined and mixed for at least 30 seconds, suitably at least 1 minute. Suitably the geopolymeric composition, aggregate and water are combined and mixed for 2 to 5 minutes.

Suitably, the weight ratio of water to geopolymeric composition is from 0.3:1 to 0.6:1, such as 0.45:1.

Suitably, the weight ratio of aggregate to binder is from 1:1 to 3:1, such as 2:1. Suitably, the weight ratio of fine aggregate to binder is from 1:1 to 3:1, such as 2:1.

The concrete mix obtained in step (1) may be placed in a mould of a desired shape to form a structure. For example, the concrete mix obtained in step (1) may be placed in a prism shaped mould to form a desired prism structure. Suitably the mould may have dimensions of 40×40×160 mm according to BS EN 196-1. Suitably the mould may be sealed once the concrete mix has been placed therein. Suitably the mould is prepared from steel or wood and sealed using a plastic cover.

Suitably, the concrete mix obtained in step (1) is left in the mould in air at room temperature for up to 24 hours. During this time, a polymerisation reaction occurs and the concrete mix undergoes a transition from its flowable state to a solid state. In other words, the concrete mix sets in the desired shape of the mould by means of the geopolymerisation reaction. At this stage however the concrete mix is not cured. Suitably the concrete mix obtained in step (1) hardens or sets to conform to the shape of the mould such that it retains this shape when removed from the mould, such that this step may be referred to as a “setting step”. Thus, step (1) of the method may include a setting step.

The concrete mix obtained in step (1) is cured, for example after the setting step referred to above. Thus, the method of the third aspect of the invention comprises the step (2) of curing the concrete mix obtained in step (1).

Suitably, in step (2), the concrete mix obtained in step (1) is cured for up to 28 days. Suitably, in step (2), the concrete mix obtained in step (1) is cured for at least 3 days. Suitably, in step (2), the concrete mix obtained in step (1) is cured for from 3 days to 28 days. In some embodiments, in step (2), the concrete mix obtained in step (1) is cured for 7 days.

Step (2) of the method of the third aspect may comprise curing the concrete mix obtained in step (1) in the presence of air and/or water. Step (2) may be conducted after a setting step as discussed above.

Step (2) of the method of the third aspect may comprise curing the concrete mix obtained in step (1) in the presence of air. This may alternatively be referred to as “air curing”. Suitably the concrete mix obtained in step (1) may be cured in air at a temperature of from 18 to 25° C., for example 20° C. This temperature may also be referred to as “room temperature” or “ambient temperature”.

Step (2) of the method of the third aspect may comprise curing the concrete mix obtained in step (1) in the presence of air at an elevated temperature. This may alternatively be referred to as “thermal curing”. For example, the concentrate mix obtained in step (1) may be cured in air at a temperature of 30° C. or above, for example of 40° C. or above. In some embodiments the concentrate mix obtained in step (1) may be cured in air at a temperature of about 50° C. In some embodiments the concentrate mix obtained in step (1) may be cured in air at a temperature of up to 50° C., for example up to 60° C. or up to 70° C. In some embodiments the concentrate mix obtained in step (1) may be cured in air at a temperature of up to 90° C. For example, the concentrate mix obtained in step (1) may be cured in air at a temperature of from 30° C. to 90° C.

When the setting step has been conducted, the concrete mix obtained in step (1) may remain in the mould (after the setting step) for curing in air. Alternatively, the concrete mix obtained in step (1) may be removed from the mould for curing in air.

Step (2) of the method of the third aspect may comprise curing the concrete mix obtained in step (1) in the presence of water. This may alternatively be referred to as “water curing”. Suitably, when the setting step has been conducted, the concrete mix obtained in step (1) may be removed from the mould for curing in water. Suitably, the concrete mix obtained in step (1), for example after the setting step, may be placed in water (such as in a water tank) at a suitable temperature. Suitably, the concrete mix obtained in step (1), for example after the setting step, may be fully immersed in water (such as in a water tank).

In some embodiments the water used for curing has a temperature of from 18 to 25° C. Suitably, the water used for curing may have a temperature of 20° C. Thus, step (2) of the method of the third aspect, may comprise curing the concrete mix obtained in step (1) in the presence of water at a temperature of from 18 to 25° C., for example at 20° C.

In some embodiments the water used for curing may have an elevated temperature. This may alternatively be referred to as “hydrothermal curing”. In some embodiments the water may have a temperature of 30° C. or above, for example of 40° C. and above. In some embodiments the water has a temperature of about 50° C. In some embodiments the water has a temperature of up to 50° C., for example up to 60° C. or up to 70° C. In some embodiments the water has a temperature of up to 90° C. For example, the water may have a temperature of from 30° C. to 90° C. Thus, step (2) of the method of the third aspect may comprise curing the concrete mix obtained in step (1) in the presence of water at a temperature of from 30 to 90° C.

Suitably, the concrete mix obtained in step (1) may be cured using one method or a combination of methods. In some embodiments the concrete mix obtained in step (1) is air cured and then water cured at ambient temperature. In some embodiments the concrete mix obtained in step (1) is air cured and then water cured at an elevated temperature (for example hydrothermally cured). In some embodiments the concrete mix obtained in step (1) is water cured at ambient temperature and then air cured. In some embodiments the concrete mix obtained in step (1) is water cured at an elevated temperature (i.e., hydrothermally cured) and then air cured. In some embodiments the concrete mix obtained in step (1) is water cured at ambient temperature and then water cured at an elevated temperature (i.e., hydrothermally cured). In some embodiments the concrete mix obtained in step (1) is water cured at an elevated temperature (i.e., hydrothermally cured) and then water cured at ambient temperature.

In some embodiments the concrete mix obtained in step (1) is water cured at an elevated temperature (i.e., hydrothermally cured) for 2 days and then air cured for 5, 12 or 26 days. In some embodiments the concrete mix obtained in step (1) is water cured at an elevated temperature (i.e., hydrothermally cured) for 2 days and then water cured at ambient temperature for 5, 12 or 26 days.

The method of the third aspect of the present invention may further comprise the step of forming the concrete mix into a concrete structure. Suitably, this step comprises casting the concrete mix in to the shape of the desired structure.

A fourth aspect of the present invention provides an alkali-activated concrete material obtained or obtainable by the method of the third aspect of the invention.

A fifth aspect of the present invention provides an alkali-activated concrete material comprising a geopolymeric composition, water and an aggregate, wherein the geopolymeric composition comprises metakaolin (MK), a source of calcium oxide and a source of aluminosilicate other than metakaolin (MK); wherein the alkali-activated concrete material has a compressive strength of at least 10 MPa as measured by compression testing. The alkali-activated concrete material, aggregate and geopolymeric composition are as described in relation to the first and second aspects.

Suitable methods of determining the compressive strength will be known to those skilled in the art. For example, the compression strength may be determined by a method according to BS EN 196-1.

The alkali-activated concrete material of the fifth aspect of the present invention has a compressive strength of at least 10 MPa. In some embodiments the alkali-activated concrete material has a compressive strength of at least 20 MPa, suitably of at least 30 MPa. In some embodiments the alkali-activated concrete material has a compressive strength of at least 40 MPa, for example at least 50 MPa. Suitably, the alkali-activated concrete material has a compressive strength of up to 60 MPa, for example up to 70 MPa. Suitably, the alkali-activated concrete material has a compressive strength of from 10 MPa to 70 MPa. For example, the alkali-activated concrete material may have a compressive strength of from 20 to 60 MPa, for example about 40 MPa.

Compressive strength is the maximum compressive stress that, under a gradually applied load, a given solid material can sustain without fracture. Suitably, the alkali-activated concrete material of the present invention can be classified according to BS 3921:1985:
1) class A when the compressive strength is greater than 70 MPa; and
2) class B when the compressive strength is from 50 MPa to 70 MPa.

In some embodiments the alkali-activated concrete material of the present invention is classified as Class A or Class B.

Alternatively, the alkali-activated concrete material of the present invention may be classified as a common brick. Suitably, the alkali-activated material has a compressive strength of from 20 MPa to 50 MPa.

Suitably, the alkali-activated concrete material of the present invention has a flexural strength of at least 0.5 MPa, for example of at least 1 MPa or at least 2 MPa. In some embodiments the alkali-activated concrete material has a flexural strength of at least 3 MPa, suitably at least 4 MPa, for example at least 5 MPa or at least 10 MPa. Suitably, the alkali-activated concrete material has a flexural strength of from 0.5 MPa to 10 MPa.

Suitable methods of determining the flexural strength will be known to those skilled in the art. For example the flexural strength may be determined by a method according to BS EN 196-1.

Suitably, the alkali-activated concrete material has an acceptable chloride ion penetrability, for example a moderate or low chloride ion penetrability. The chloride ion penetrability is suitably considered as a method to evaluate the durability of the material. Suitably, chloride ion penetrability may be determined by surface electrical resistivity testing. For example, the surface electrical resistivity results may be compared with a chloride penetration classification, for example as published by AASHTO T 358. For example, the skilled person may consider that a surface resistivity of about 15 kΩ cm represents a moderate chloride ion penetrability and that a surface resistivity of about 25 kΩ cm represents a low chloride ion penetrability. Suitably, the higher the surface resistivity the lower the chloride ion penetrability.

Suitably, the alkali-activated concrete material has a surface resistivity of more than 10 kΩ cm, suitably more than 20 kΩ cm, for example more than 30 kΩ cm. In some embodiments the alkali-activated concrete material has a surface resistivity of more than 40 kΩ cm, for example more than 50 kΩ cm.

Suitably, the alkali-activated material has an acceptable water absorption rate, for example a moderate or low water absorption rate. A low water absorption rate provides better resistance to damage by freezing.

Suitably, the alkali-activated material has a water absorption rate of less than 10%, for example less than 5%. Suitably, the alkali-activated material has a water absorption rate of less than 4%, for example less than 3%.

Suitably, the water absorption rate may be determined according to a method of BS EN 771-1:2003.

The resulting alkali-activated material can be used for making brick, block or concrete.

A sixth aspect of the present invention provides a concrete structure formed from an alkali-activated concrete material according to the fourth or fifth aspect of the present invention.

Any desirable structure may be formed, such as a brick, block, pillar or column. Suitably the structure is a brick.

A seventh aspect of the present invention provides the use of an alkali-activated concrete material according to the fourth or fifth aspect of the present invention in construction.

An eighth aspect of the present invention provides the use of a concrete structure according to the sixth aspect of the present invention in construction.

For a better understanding of the invention, and to show how exemplary embodiments of the same may be carried into effect, reference will be made, by way of example only, to the accompanying diagrammatic Figures, in which:

FIG. 1 shows powder X-Ray Diffraction (XRD) data collected for MK, BPD and NP.

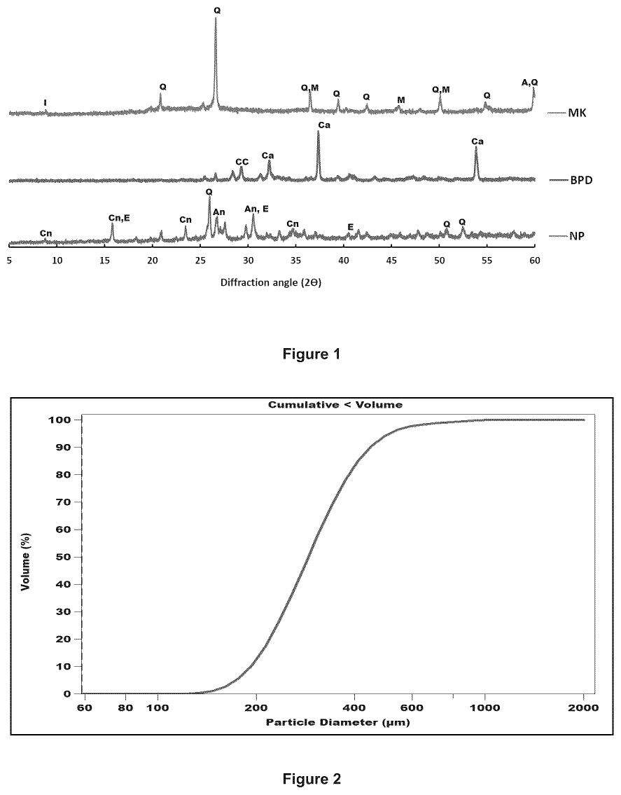

FIG. 2 shows the particle size distribution (PSD) of sand used for making mortar with a geopolymeric composition of the present invention.

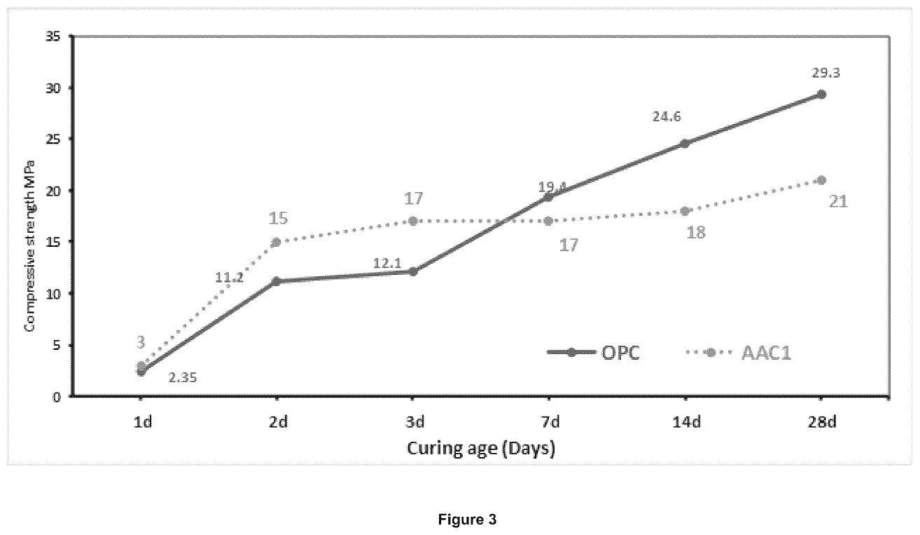

FIG. 3 shows the compressive strength of mortar prepared from a geopolymeric composition of the present invention and comparison with mortar prepared from conventional cement.

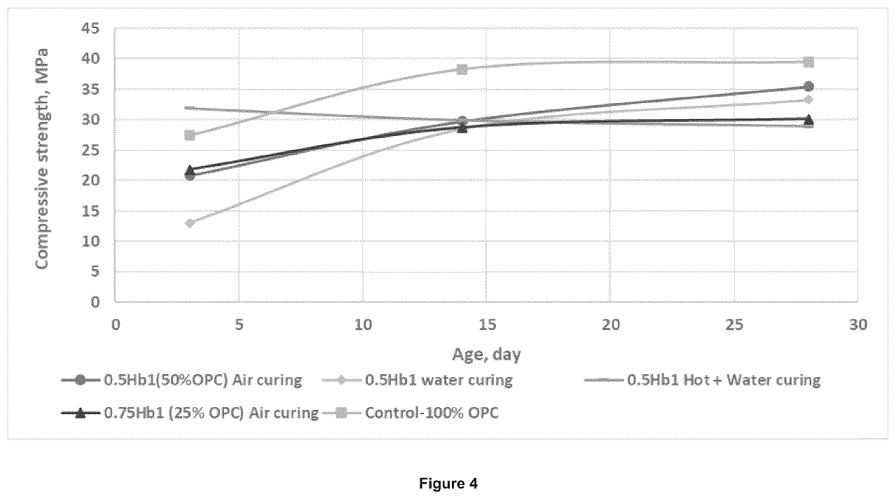

FIG. 4 shows the compressive strength of hybrid mortar prepared using different amounts of the geopolymeric composition of the present invention under various curing conditions and comparison with mortar prepared from conventional cement.

### EXAMPLES

The invention will now be described with reference to the following non-limiting examples.

### Example 1: Preparation of an Alkali-Activated Material

Geopolymeric compositions were prepared comprising MIK, NP and BPD. The chemical composition of each of MK, NP and BPD are illustrated in Table 1.

TABLE 1
Composition of MK, NP and BPD

| Com- | | | | | | | | |
|---|---|---|---|---|---|---|---|---|
| ponents | | | | | | | | |
| (wt. %) | SiO₂ | Al₂O₃ | Fe₂O₃ | CaO | Na₂O | K₂O | MgO | TiO₂ |
| MK | 55 | 40 | 1.4 | 0.15 | 0.4 | 0.4 | 0.95 | 1.7 |
| NP | 46.6 | 30.4 | 3.8 | 4.5 | 3.9 | 6 | 4.2 | 0.6 |
| BPD | 20.7 | 1.0 | 1.7 | 53.0 | 2.1 | 5.0 | 1.2 | 0.3 |

Geopolymeric compositions were prepared with the amounts of each of the MK, NP and BPD set out in Table 2.

TABLE 2
Geopolymeric Composition

| Mix ID | Geopolymeric Composition Content |
|---|---|
| Inventive Example 1 | 35 wt % MK; 35 wt % BPD and 30 wt % NP |
| (AAC1) | |
| Comparative Example 1 | 50 wt % BPD and 50 wt % NP |
| (AAC2) | |
| Comparative Example 2 | 50 wt % BPD and 50 wt % MK |
| (AAC3) | |
| Comparative Example 3 | 100 wt % Cement |
| (OPC) | |

The elemental composition of raw materials was determined using a Shimadzu EDX 720 and energy dispersive X-ray fluorescence (EDXRF) spectrometer.

The XRD measurements were carried out using a Rigaku mini-flex diffractometer (mini-flex goniometer), with Cuk X-ray radiation (30 kV voltage and 15 mA current at scanning speed of 2.0 deg./min in continuous scan mode) and scanning range (2θ) of 5-60°.

The XRD data for each of MK, BPD and NP is shown in FIG. 1.

The geopolymeric compositions according to Table 2 were mixed with kiln dried sand with a particle size distribution (PSD) shown in FIG. 2 and a specific gravity of 2.62 (measured by Quantachrome gas expansion multi-pycnometer purged with helium gas) with a weight ratio of geopolymeric composition:sand of 1:2 and a water:geopolymeric composition weight ratio of 0.45:1 to produce a mortar.

The mortars were mixed using a Hobart mixer and poured into steel prism moulds (each mould having dimensions of 40 mm×40 mm×160 mm).

The mortars were demoulded after 24 hours and cured in water for 1 day at 50° C. and then cured in room temperature (20° C.) water. The compressive strength was measured according to the BS 196-1. The test was carried out using a Control Automax 5 compression tester, with a load rate of 0.4 MPa/s. The resulting compressive strength and its comparison against conventional cement (OPC) are shown in FIG. 3. The comparative examples 2 and 3 (AAC2 & AAC3) showed no strength and are therefore not shown in FIG. 3.

### Example 2: Hybrid Binder Compositions

Hybrid binder compositions were prepared according to Table 3. The geopolymeric compositions were mixed with kiln dried sand with a particle size distribution (PSD) shown in FIG. 2 and a specific gravity of 2.62 with a mixing weight ratio of binder:sand of 1:2 and water:binder of 1:0.55 to produce a mortar. The mortars were mixed using a Hobart mixer and poured into steel prism moulds (each mould having dimensions of 40 mm×40 mm×160 mm).

The mortars were demoulded after 24 hours and cured as also shown in Table 3.

TABLE 3

| Mix ID | Hybrid Binder Composition Content | Curing method |
|---|---|---|
| Inventive | 50 wt % geopolymeric composition (35 | Room temperature air curing |
| Example 2 | wt % MK + 35 wt % BPD + 30 wt % NP) + | Room temperature water |
| (0.5 Hb1) | 50 wt % OPC | curing |
| | | 3 days 50° C. water and room |
| | | temperature water curing |
| Inventive | 75 wt % geopolymeric composition (35 | Room temperature air curing |
| Example 3 | wt % MK + 35 wt % BPD + 30 wt % NP) + | |
| (0.75 Hb1) | 25 wt % OPC | |
| Comparative | 100 wt % cement | Room temperature water |
| Example 3 | | curing |
| (OPC) | | |

The resulting compressive strength of the inventive examples and a comparison against conventional cement (OPC) is shown in FIG. 4.

FIG. 4 shows a comparison of the compressive strength of hybrid binders in comparison to the conventional OPC (Comparative Example 3). The mortar comprising 50 wt % OPC and 50 wt % alkali-activated material (0.5Hb1) showed comparable compressive strength to OPC mortar with a compressive strength of 35 MPa after curing in air for 28 days, The mortar comprising 25 wt % OPC and 75 wt % alkali-activated material (0.75Hb1) in the hybrid binder achieved a compressive strength of 30 MPa, following air curing.

Therefore, use of a hybrid binder comprising both OPC and the geopolymeric composition means that water and hot water curing is not necessary, which reduces the energy cost of the process.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

For the avoidance of doubt, wherein amounts of components in a composition are described in wt %, this means the weight percentage of the specified component in relation to the whole composition referred to. For example, “wherein the BPD comprises 35 wt % to 65 wt % calcium oxide” means that 35 wt % to 65 wt % of the BPD is provided by calcium oxide.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

2. A composition for forming an alkali-activated concrete material, the composition comprising a geopolymeric composition, water and an aggregate, wherein the geopolymeric composition comprises metakaolin (MK), a source of calcium oxide and a source of aluminosilicate other than metakaolin (MK).

3. A method of forming an alkali-activated concrete material, the method comprising:
(1) mixing a geopolymeric composition, water and an aggregate to obtain a concrete mix; and
(2) curing the concrete mix obtained in step (1);
wherein the geopolymeric composition comprises metakaolin (MK), a source of calcium oxide and a source of aluminosilicate other than metakaolin (MK).

4. A method according to claim 3, wherein step (2) comprises curing the concrete mix in the presence of air and/or water.

5. A method according to claim 4, wherein the concrete mix is cured in air at a temperature of from 18 to 25° C.

6. A method according to claim 4, wherein the concrete mix is cured in water at a temperature of from 18 to 25° C.

7. A method according to claim 4, wherein the concrete mix is cured in water at a temperature of from 30° C. to 90° C., preferably about 50° C.

8. A composition according to claim 2, wherein the aggregate comprises sand, gravel, limestone, sandstone, chalk, soil or combinations thereof, preferably sand.

9. A composition according to claim 1, wherein the geopolymeric composition comprises from 25 wt % to 35 wt % of metakaolin (MK).

10. A composition according to claim 1, wherein the source of calcium oxide is bypass dust (BPD), suitably wherein geopolymeric composition comprises from 25 wt % to 35 wt % of bypass dust (BPD).

11. A composition according to claim 1, wherein the source of aluminosilicate other than metakaolin (MK) is natural pozzolan (NP), suitably wherein the geopolymeric composition comprises from 30 wt % to 50 wt % of natural pozzolan (NP).

12. A composition according to claim 1, wherein the metakaolin (MK) comprises from 45 to 60 wt % silicon dioxide and/or from 30 to 50 wt % aluminium oxide.

13. A composition according to claim 10 wherein the bypass dust (BPD) comprises from 15 to 30 wt % silicon dioxide and/or from 40 to 65 wt % calcium oxide.

14. A composition according to claim 11, wherein the natural pozzolan (NP) comprises from 35 to 55 wt % silicon dioxide and/or from 20 to 40 wt % aluminium oxide.

15. A hybrid binder composition comprising a geopolymeric composition according to claim 1 and cement, preferably OPC.

16. A method according to claim 3, further comprising the step of forming the concrete mix into a concrete structure.

17. An alkali-activated concrete material obtained or obtainable by the method of claim 3.

18. A concrete structure obtained or obtainable by the method of claim 16.

19. An alkali-activated concrete material derived from a geopolymeric composition, water and an aggregate, wherein the geopolymeric composition comprises metakaolin (MK), a source of calcium oxide and a source of aluminosilicate other than metakaolin (MK); wherein the alkali-activated concrete material has a compressive strength of at least 10 M Pa as measured by compression testing.

20. A concrete structure formed from an alkali-activated concrete material according to claim 19.

21. Use of an alkali-activated concrete material according to claim 19 in construction.

22. Use of a concrete structure according to claim 20 in construction.
